(19) United States
(12) Patent Application Publication
(10) Pub. No.: US 2019/0155301 A1
(43) Pub. Date: May 23, 2019

(54) CAMERA BASED SYSTEM FOR DETERMINING ROBOT HEADING IN INDOOR ENVIRONMENTS

(71) Applicant: STOCKED ROBOTICS, INC., Austin, TX (US)

(72) Inventor: Saurav Agarwal, Round Rock, TX (US)

(73) Assignee: STOCKED ROBOTICS, INC., Austin, TX (US)

(21) Appl. No.: 16/255,399

(22) Filed: Jan. 23, 2019

Related U.S. Application Data
(63) Continuation-in-part of application No. 16/198,579, filed on Nov. 21, 2018.
Application No. 16/198,579 is a continuation-in-part of application No. 16/183,592, filed on Nov. 7, 2018.
(60) Provisional application No. 62/776,073, filed on Dec. 6, 2018.
(60) Provisional application No. 62/589,900, filed on Nov. 22, 2017.
(60) Provisional application No. 62/582,739, filed on Nov. 7, 2017.
(60) Provisional application No. 62/743,584, filed on Oct. 10, 2018.
(60) Provisional application No. 62/620,819, filed on Jan. 23, 2018.

(51) Int. Cl. G05D 1/02; G06K 9/00; G06K 9/52; G06K 9/20

(52) U.S. Cl. CPC G05D 1/0246; G06K 9/00791; G06K 9/209; G06K 9/52; G06K 9/525

(57) ABSTRACT

A method for controlling a vehicle, comprising generating image data at a camera system of a robotic vehicle, receiving the image data at a processor of the robotic vehicle, identifying a plurality of bright spots in the image data using the processor, computing a boundary for the plurality of bright spots and generating control data as a function of the boundary.

### RELATED APPLICATIONS

The present application claims benefit of and priority to U.S. Provisional patent applications 62/582,739, 62/589,900, 62/620,819, 62/743,584 and 62/776,033, and U.S. patent applications Ser. Nos. 16/183,592 and 16/198,579, each of which is hereby incorporated by reference for all purposes as if set forth herein in their entireties.

### TECHNICAL FIELD

The present disclosure relates generally to robotic systems, and more specifically to a camera-based system for determining robot heading in an indoor environment.

### BACKGROUND OF THE INVENTION

Robotic systems are known, but control of robotic systems usually requires dedicated control devices or systems.

### SUMMARY OF THE INVENTION

A method for controlling a vehicle is disclosed that includes generating image data at a camera system of a robotic vehicle, receiving the image data at a processor of the robotic vehicle, identifying a plurality of bright spots in the image data using the processor, computing a boundary for the plurality of bright spots and generating control data as a function of the boundary.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a multi-camera rig, in accordance with an example embodiment of the present disclosure;

FIG. 2 is a diagram of a multi-camera rig mounted on a robot vehicle with a mast, in accordance with an example embodiment of the present disclosure:

FIG. 3 is a diagram of a vehicle and points of intersection of a line between the cameras and ceiling lights at a virtual plane;

FIG. 4 is a diagram of a set of perpendicular lines as constructed in accordance with an example embodiment of the present disclosure;

FIG. 5 is a flowchart for the various major components and flow of data.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present application claims benefit of and priority to U.S. Provisional patent applications 62/582,739, 62/589,900, 62/620,819, 62/743,584 and 62/776,033, and U.S. patent applications Ser. Nos. 16/183,592 and 16/198,579, each of which is hereby incorporated by reference for all purposes as if set forth herein in their entireties.

Mobile robots can be used in indoor environments such as factories, warehouses and distribution centers to move goods. These robots can rely on external or internal navigation systems to determine their location and find paths from their current location to a target location. A common problem for such robots is that their location information can often be quite noisy and sometimes incorrect. A robust technique to determine location information is to first determine the vehicle heading with respect to a fixed coordinate system and then use that heading information along with other sensor data to estimate the robot position. The present disclosure provides a camera-based system to estimate a vehicle heading with respect to a building's fixed direction.

When an autonomous robot is first introduced in an unknown environment, it builds a map of its environment and then uses that map to generate location data. It is well understood that if a robot is not able to track to its heading with respect to a fixed environmental frame, it position estimate may often drift. The present disclosure provides a multi-camera system that uses visual image processing to track ceiling light fixtures around the vehicle in indoor industrial environments, including but not limited to factories, warehouses, distribution centers, office buildings or other suitable locations, and can estimate the robot's heading direction, also commonly referred to as attitude or orientation. The disclosed method and system developed provides for robust autonomy for mobile robots.

The present disclosure includes a camera system comprising one or more cameras mounted a mobile robot such that the cameras can observe forward, rear, upwards and side views of the surrounding environment to detect, recognize and track man-made or naturally-occurring features, in order to determine robot orientation with respect to a building. A multi-camera rig mounted on the robot's roof or other suitable structure can capture images of the forward, rear, left, right and upward (ceiling) direction. A gyroscope system which detects body roll rate in all three dimensions which is mounted on the robot can aid tracking of visual features. A computer system connected to camera-rig and gyroscope running computer vision and pattern recognition software can estimate vehicle orientation from image data.

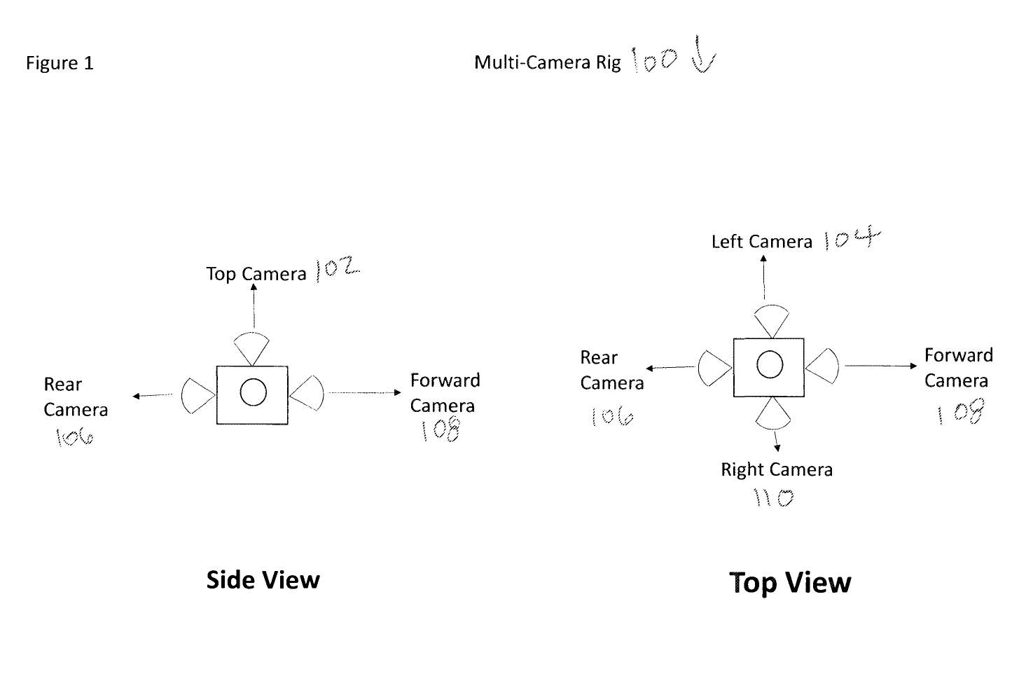

FIG. 1 is a diagram of a multi-camera rig 100, in accordance with an example embodiment of the present disclosure. Multi-camera rig 100 includes top camera 102, left camera 104, rear camera 106, forward camera 108 and right camera 110, although other suitable combinations and arrangements of cameras or other suitable sensors can also or alternatively be used.

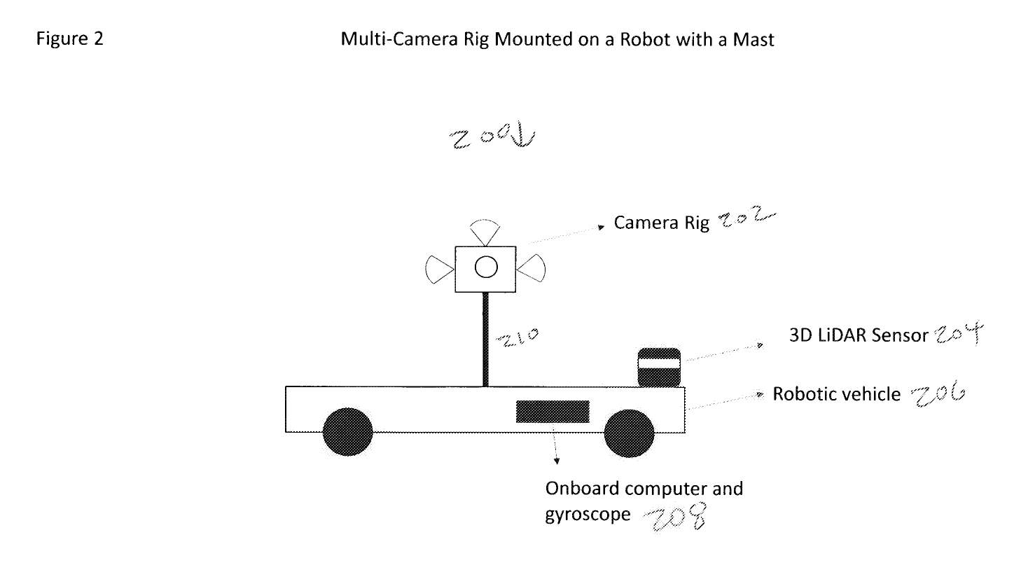

FIG. 2 is a diagram 200 of a multi-camera rig mounted on a robot vehicle 206 with a mast 210, in accordance with an example embodiment of the present disclosure. Diagram 200 shows camera rig 202 mounted on a robot vehicle 206 equipped with other perception sensors such as 3D LiDAR sensor 204 and onboard computer and gyroscope 208. The system is configured to determine the vehicle's orientation with respect to the building, such as by using the following steps, or in other suitable manners.

First, the image from each camera can be converted to grayscale or other suitable formats. In each camera image, the bright spots representing light fixtures in the image plane can be detected by thresholding the image and setting every pixel value below a threshold of 0.0 to 0. For the forward, rear and sideways facing cameras, only the upper half of the image plane can be taken into consideration. The threshold may need to be tuned manually for different environments, because the intensity of light fixtures can vary between different buildings.

A closing operation can be performed on each image shape, to compute a closure or boundary for connected bright spots. Once the boundary is computed for each bright spot, its centroid can be computed using a centroiding algorithm or other suitable operations. A virtual horizontal plane can be assumed to exist at a suitable location, such as 1 meter above the camera rig. The intersection of the virtual horizontal plane can be computed with the lines joining each camera's optical center to the centroids of bright spots (ceiling lights), as viewed from that camera.

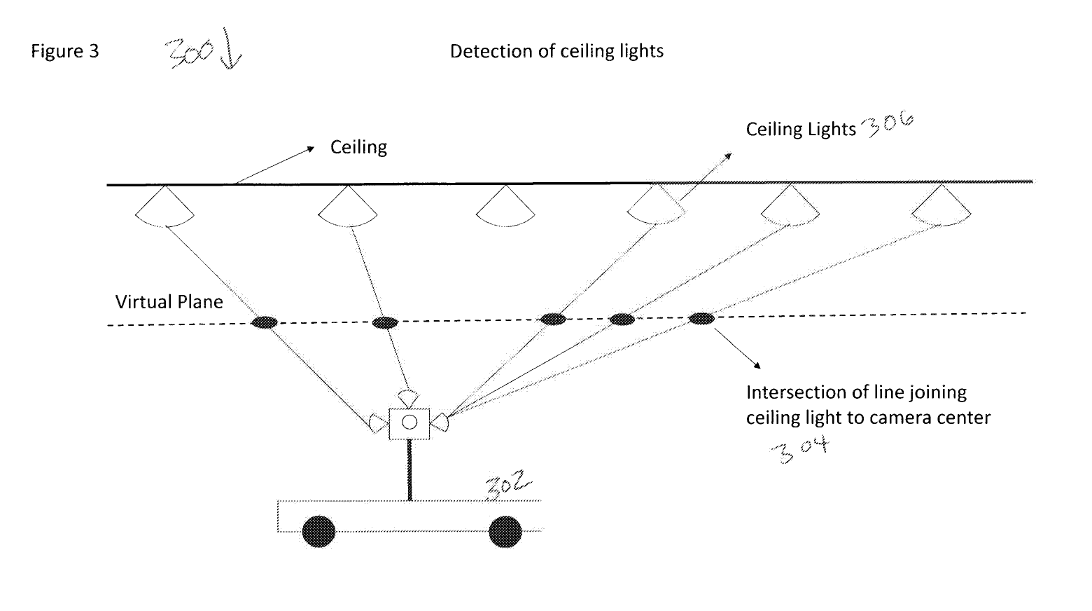

FIG. 3 is a diagram 300 of a vehicle 302 and points of intersection 304 of a line between the cameras and ceiling lights 306 at a virtual plane. Diagram 300 shows that the process generates a set of points through which best fit lines can be computed.

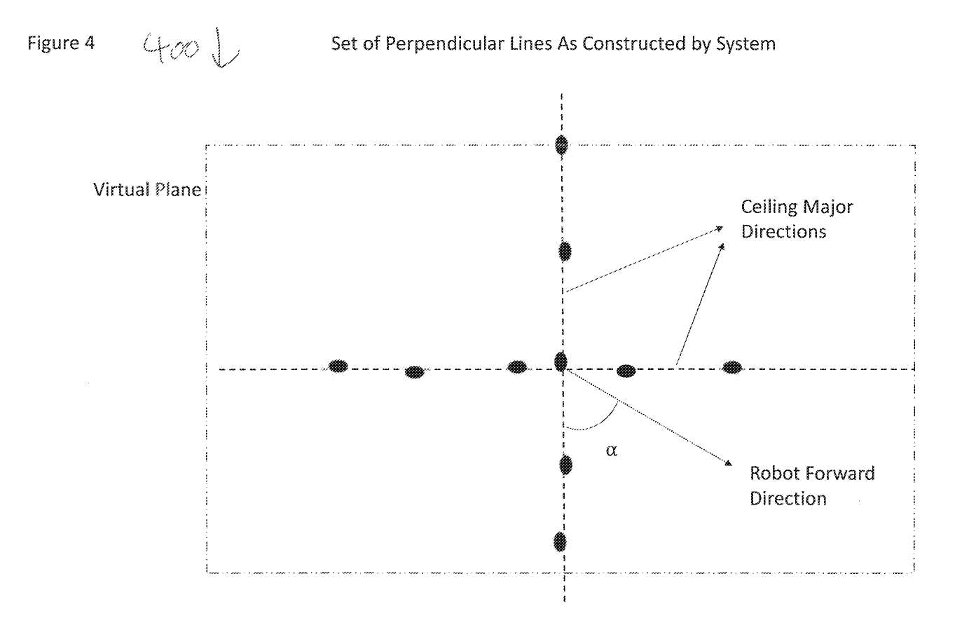

FIG. 4 is a diagram 400 of a set of perpendicular lines as constructed in accordance with an example embodiment of the present disclosure. Due to the grid like nature of industrial buildings, a set of perpendicular lines can be generated which can then be tracked to determine the robot orientation as a rotation relative to the perpendicular line pattern (shown as α). Each perpendicular line represents a ceiling major direction, as the ceiling can be assumed to be a plane which can only have two major directions. A gyroscope can be used to propagate a heading estimate when lighting fixtures are not visible to the cameras.

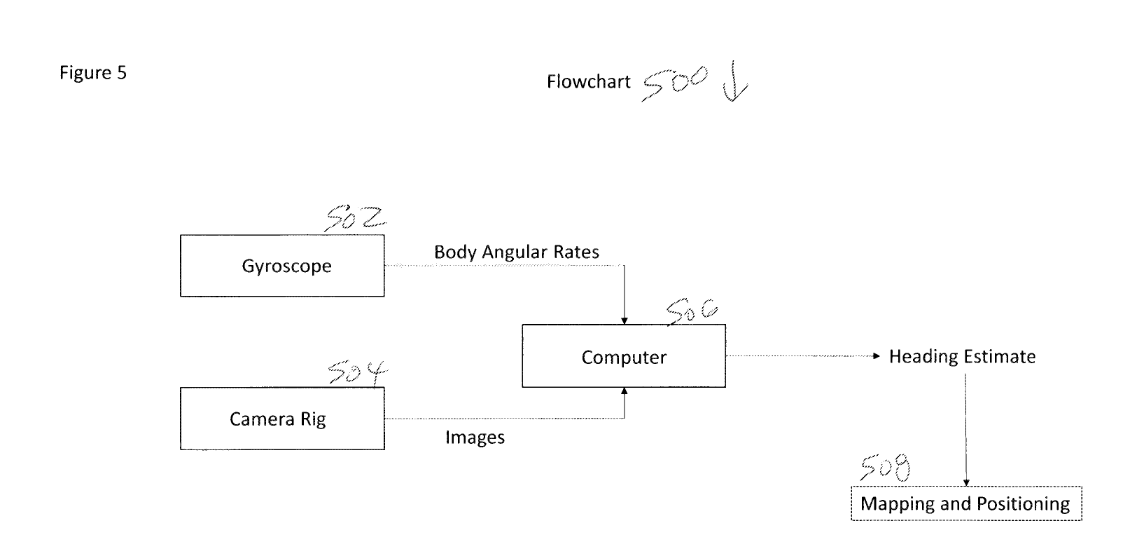

FIG. 5 is a flowchart 500 for the various major components and flow of data. At 502, a gyroscope generates body angular rates, and at 504 a camera rig generates image data. At 506, a processor that is configured as discussed herein receives the body angular rate data and image data and generates heading estimates, such as by performing a closing operation on each image shape to compute a closure or boundary for connected bright spots, by determining the centroid using a centroiding algorithm, by applying an assumed virtual horizontal plane to identify an intersection of the virtual horizontal plane with the lines joining each camera's optical center to the centroids of bright spots (ceiling lights), or using other suitable algorithms. Once the orientation of the robot is ascertained, then that orientation data is provided to a positioning and mapping system at 508 for use as a fixed reference.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for controlling a vehicle, comprising:
generating image data at a camera system of a robotic vehicle;
receiving the image data at a processor of the robotic vehicle;
identifying a plurality of bright spots in the image data using the processor;
computing a boundary for the plurality of bright spots; and
generating control data as a function of the boundary.

2. The method of claim 1 wherein generating the control data further comprises determining a centroid of the plurality of bright spots.

3. The method of claim 2 wherein generating the control data further comprises determining a plurality of lines, each line connecting one of the plurality of bright spots to a point of view.

4. The method of claim 3 wherein generating the control data further comprises determining an intersection of a virtual horizontal plane with the plurality of lines.

5. The method of claim 4 wherein generating the control data further comprises generating a forward direction as a function of the intersection of the virtual horizontal plane with the plurality of lines.

6. The method of claim 5 wherein generating the control data further comprises determining an angular displacement relative to a ceiling major direction.

7. The method of claim 1 wherein generating the image data at the camera system of the robotic vehicle comprises generating a series of sets of image data for each of a plurality of different directions.

8. The method of claim 1 wherein generating the image data at the camera system of the robotic vehicle comprises generating a series of sets of image data for a front direction, a rear direction, a top direction, a left direction and a right direction.

9. The method of claim 1 wherein identifying the plurality of bright spots in the image data using the processor comprises setting a plurality of pixel values that are below a predetermined threshold to a predetermined value.

10. The method of claim 1 wherein identifying the plurality of bright spots in the image data using the processor comprises analyzing only an upper half of an image plane in the image data.

11. The method of claim 1 wherein identifying the plurality of bright spots in the image data using the processor comprises adjusting a threshold as a function of a building identifier.

12. The method of claim 1 wherein computing a boundary for the plurality of bright spots comprises generating a centroid using the plurality of bright spots.

13. A system for controlling a vehicle, comprising:
a camera system of a robotic vehicle configured to generate image data;
a processor of the robotic vehicle configured to receive the image data;
the processor of the robotic vehicle configured to identify a plurality of bright spots in the image data;
processor of the robotic vehicle configured to compute a boundary for the plurality of bright spots; and
processor of the robotic vehicle configured to generate control data as a function of the boundary.

14. The system of claim 13 wherein the processor is configured to determine a centroid of the plurality of bright spots.

15. The system of claim 14 wherein the processor is configured to determine a plurality of lines, each line connecting one of the plurality of bright spots to a point of view.

16. The system of claim 15 wherein the processor is configured to determine an intersection of a virtual horizontal plane with the plurality of lines.

17. The system of claim 13 wherein the processor is configured to generate a forward direction as a function of the intersection of the virtual horizontal plane with the plurality of lines.

18. The system of claim 13 wherein the processor is configured to determine an angular displacement relative to a ceiling major direction.
